(19) United States
(12) Patent Application Publication
(10) Pub. No.: US 2002/0156749 A1
(43) Pub. Date: Oct. 24, 2002

(54) Time driven reservation system

(76) Inventor: John Sardy, Tarrytown, NY (US)

Correspondence Address: LIEBERMAN & NOWAK LLP, 350 FIFTH AVE., SUITE 7412, NEW YORK, NY, 10118, US

(21) Appl. No.: 10/128,750

(22) Filed: Apr. 23, 2002

Related U.S. Application Data
(60) Provisional application No. 60/286,206, filed on Apr. 24, 2001.
(60) Provisional application No. 60/286,174, filed on Apr. 24, 2001.

(51) Int. Cl. G06F 17/60

(52) U.S. Cl. 705/80

(57) ABSTRACT

In a preferred embodiment, the present invention provides a method and apparatus whereby sellers of expiring goods or services may communicate and post, though a global network, an asking price, which has a predetermined starting price as well as a predetermined final price with automatic increments that are made known to buyers who are then able to make a binding offer through the global network at a certain point in time thereby completing the transaction at the specific price the buyer has contracted and guaranteed to pay with a secure credit card transaction. Additionally, the present invention allows the seller to communicate to the buyer with a post on a service's website the increasing value of an expiring good or service during the course of time until the expiration of the good or service thereby creating an incentive and stimulating a more rapid sale.

### RELATED APPLICATIONS

This application claims the filing dates of provisional application 60/286,206, filed Apr. 24, 2001, and provisional application 60/286,174, filed Apr. 24, 2001.

### FIELD OF THE INVENTION

The present invention relates to a method and system for a reservation service for events, in particular dinner reservations at top-rated restaurants, that rewards users for making early reservations while giving them a choice for paying a premium for a guaranteed reservation, said premium increases as the time of the reservation draws nearer.

### DESCRIPTION OF THE PRIOR ART

Reservation and ticketing methods for users to reserve and purchase tickets for future events are well-known. In recent year numerous companies were started to take advantage of the Internet to give consumers a new convenience in making reservations for movie, theatre and concert tickets, airline tickets, rental cars and hotel arrangements. There are also websites dedicated to arranging reservations for selected restaurants. While some of these services offer a straight-forward “first come, first served” system, auction or so called “reverse auction” services that let users decide how much they want to pay for a service have also enjoyed a degree of success.

While these prior art methods fulfill their respective, particular objectives and requirements, the aforementioned methods do not address a well-known problem, that of the immense difficulty in obtaining confirmed reservations for top rated restaurants during peak days such as New Year's eve or Valentine's day, especially for the procrastinator who has to scramble at the last minute to obtain a table.

Despite the fact that everyone knows you should make reservations as early as possible for these restaurants (which are typically booked solid year-round), inevitably the best-laid plans of mice and men go awry and these restaurants are constantly inundated with desperate pleas for a table. A potential guest without a reservation, upon showing up and the restaurant and being told there are no tables available, may nonetheless resort to hassling the maitre'd, such as attempts to slip a bribe to the maiter'd because of the known practice of maitre'ds who'd “reserve” a special table just in case a celebrity or a special or a long-time guest of the restaurant would show up, or in hope that the maitre'd might simply bump him to the front of the waiting list. This can lead to abuses by maitre'ds at these establishments, because they have the power (or are perceived to have the power) to grant or deny a potential patron's frantic request, and creatics an environment that can be confrontational or embarrassing. While an unscrupulous maitre'd may have no problem with accepting the bribe, many maitre'ds and even restaurant owners frown on this practice. And even if the maitre'd would accept such a bribe, the guest has no bargaining power whatsoever and has to guess the amount of an appropriate bribe.

This practice creates false expectations, embarrassment, long waiting times, resentment and hostility towards the restaurant and maitre'd, and may lead to the restaurant losing potential customers and their business.

The use of an auction system is impractical for addressing the problem discussed above for a variety of reasons. An auction system where the reservation goes to the highest bidder unnecessarily creates feelings of resentment towards the restaurant and parties involved in a bidding war. Losing bidders will feel as if they were snubbed by the restaurant and the filthy rich who can afford to place the high bid. Bidding wars that escalates the price for a table drastically would become common. Further, because the “closing date” of the auction (i.e., when the table is actually required) is variable, it would require a high number of auctions to address these sudden, last minute demands.

It is, therefore, an object of the invention to provide a method and system for restaurants to better control their bookings, especially for peak periods, that removes the potential for abuse by unscrupulous maitre'ds, and removes the hassle of the guest and the maitre'ds from having to negotiate and/or bribe for a table.

Another object is to address the global demand for hard-to-get or last minute reservations for these world famous restaurants by making them available on the Internet, instead of to the very few who are able to walk into a particular restaurant and harass a maitre'd.

It is another object of the invention to promote fairness in the market place by allowing every one who desires a last minute or hard-to-get reservation to know exactly what the asking price is, without having to resort to a auction system where the reservation goes to the highest bidder.

It is another object of the invention to create a method for effectuating reservations and sales that rewards users for making early reservations to lock in their bookings, while assigning a known and increasing premium for late bookings as the time for the booking draws nearer.

It is another object of the invention that lets users known definitively whether a last minute reservation is available, free of hassles or embarrassment, and lets them know exactly what the required premium is for making this last minute reservation.

It is another object of the invention to provide a method and system for effectuating the sale of a valueless service, namely, the restaurant reservation itself, by giving it a monetary value because of the high demand for it. It is a further object to remove the embarrassing bargaining process between a guest and the maitre'd by giving the guest a fixed and known price to obtain a table.

Yet another object of the invention is to create a fair and market-driven system for assigning a limited resource in high demand, namely, a table at a Top-Rated restaurant during a peak season. Another related object of the invention is to make available globally this limited resource.

These together with other objects of the invention, along with the various features of novelty which characterize the invention, it's operating advantages and the specific objects attained by it's uses, reference should be made to the accompanying drawings and descriptive matter in which there are illustrated preferred embodiments of the invention.

### SUMMARY OF THE INVENTION

The above and related objects are accomplished by a novel system and method for effectuating the sale of a valueless service, namely a restaurant reservation, by giving it value because of the demand for it. The system, accessible through the Internet and/or calling a telephone number, offers up-to-the-minute information on the availability and pricing for reservations at selected top-rated restaurants for any given date and time, even if the table is required immediately.

The reservations made at any given time through this system will carry a value or fee, said fee increasing as a reservation is made later and later. The reservations will be offered at a nominal or free starting price for a fixed time period before the required date. This can be optionally coupled with a cancellation or no-show fee that also increases as the time approaches.

The system is better illustrated by the following examples. All monetary amounts and times are for illustration only, and are not meant to be limitations. Further, in this discussion, the words “system,” “service,” “method” and “invention” are meant to be synonyms.

Example 1: A person wants to reserve a table for Valentine's day, Feb. 24, 2003. He accesses the service on or before Aug. 24, 2002, or more than six months before the required date. The service lists a number of restaurants with openings for that night. He selects one and in response the service informs him that no premium will be charged for making this early reservation, and the reservation can be made for free if he confirms it now. Having firm plans and wanting to lock in the reservation as soon as possible, the person confirms the reservation by giving the service his credit card information. His credit card will not be charged unless he cancels the reservation close to the time of the reservation and invoking a cancellation fee.

Example 2: A second person wants to reserve a table for Valentine's day, Feb. 24, 2003. He accesses the service on or after Nov. 25, 2002, or less than three months before the required date. The service lists a number of restaurants with openings for that night. He selects one and in response the service informs him that if he confirms his reservation now, a premium of 20 dollars will be charged. The service further informs him that if he decides to make his reservation a month from now, the premium charged then will be 40 dollars. Through a system of menus on the Internet website or through the phone, the person can find out exactly how much the premium will be at any particular date and time if he should decide to defer making the reservation. He may not want to commit right now because his dinner plans for Feb. 14, 2003, are still being finalized. He was informed by the service that a cancellation charge of 50 (on top of the non-refundable reservation charge) will be charged if he should decide to cancel less than a pre-determined number of days before the date of the reservation.

He decides to make the reservation now. The non-refundable charge is $20 dollars. The system charges his credit card and confirms his reservation.

Example 3: It is now Feb. 14, 2003, 5:30 pm. A third person is frantically searching for a table at a top-rated restaurant for tonight because she forgot to make a reservation for valentine's day. She accesses the system and was informed that there is a table available at a restaurant for a premium of $50 dollars. Thankful that she can make a reservation at this late time, she gladly pays the $50 premium.

Example 4: It is now 8:00 pm on valentine's day. A fourth person is going out for drinks with a new date. He didn't make any prior plans for dinner. Seeing how well the evening is going, he decides on a whim to impress his date by taking her to a fancy restaurant. Knowing that he needs a table right away, and there is no chance he can walk into a restaurant on valentine's day and get a table, he calls the system as his best and only hope. The system informs him that there is a table available right away at Fancy Restaurant, but that the reservation will cost $200. The system also informs him that the same reservation at Fancy Restaurant for 10:00 pm costs $100 if he made the reservation right now. He has all the information he needs to make his decision: Pay $200 for a table now, or $100 for a table at the “second shift.” He decides to spring for the table right away so they don't have to wait until 10:00 pm, and pays the $200 premium.

As illustrated by the above examples, the premium on a reservation increases the later you make the reservation. This expands on the traditional expression “First Come, First Served” by assigning a pre-determined value to an expiring item or service. The system rewards the early planners and locks them in for the restaurant, which knows it can fill these tables months in advance. Additionally, an added incentive could be given for the early planners, such as a free gift or a discount on their purchase. Once the free period passes, a premium for making the reservation will be charged, with the premium increasing day by day, and then hour by hour on the required date.

This service is offered as an alternative to turning away valuable restaurant guests and could ideally be a link from the restaurants own website where the guest would click on a link to the service in the perspective restaurant website. It is a solution to the need expressed by countless guests who are in urgent need for last minute or hard-to-get reservations. Restaurants simply offer a limited number of reservations to a club looking for last minute and hard-to-get reservations. It is a system to hold reservations in reserve while making them available to those who are looking at the last minute and did not called prior to the needed date.

To make available these last minute reservations to the system, a restaurant keeps a certain number of reservations un-available off its first come—first served list. These reservations are kept available through the system to those that seek last minute reservations. The price ultimately paid for the reservation in no way affects the service or food rendered since these elements must be billed separately. It is ultimately a new and/or improved service provided by the restaurant establishment that desire to offer hard to get reservations globally instead of only to those who would be able to walk into the restaurant and barter with the maitre'd.

### BRIEF DESCRIPTION OF THE DRAWINGS

The invention will be better understood and objects other than those set forth above will become apparent when consideration is given to the following detailed description thereof. Such description makes reference to the annexed drawing wherein:

FIG. 1 is a flow chart detailing the steps of the method of the invention from the seller's perspective.

FIG. 2 is a flow chart detailing the steps of the method of the invention from a buyer's perspective.

FIG. 3 is a flow chart detailing the steps post-sale.

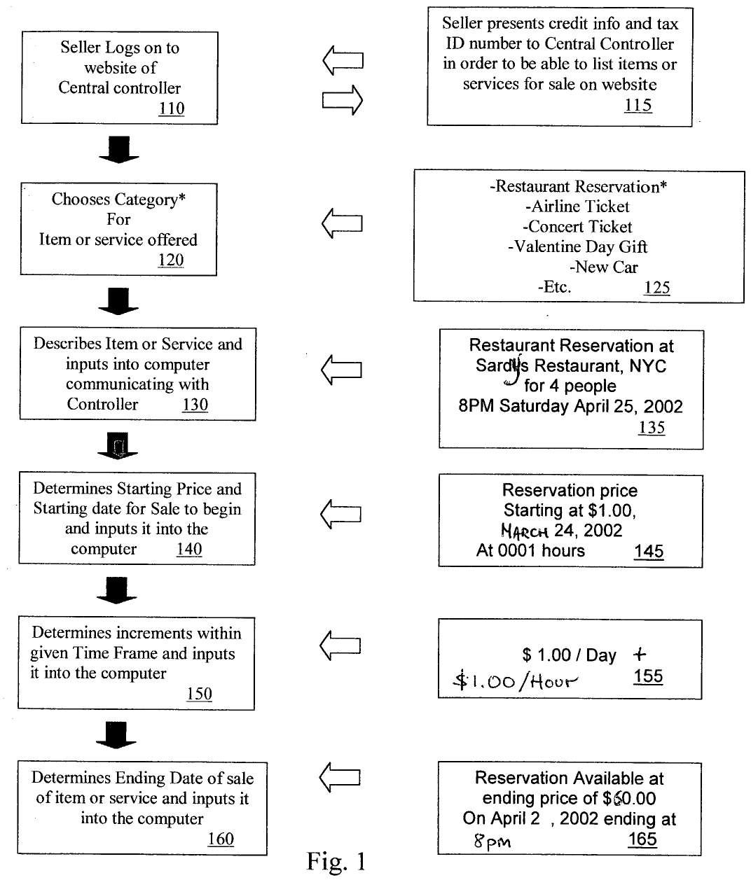

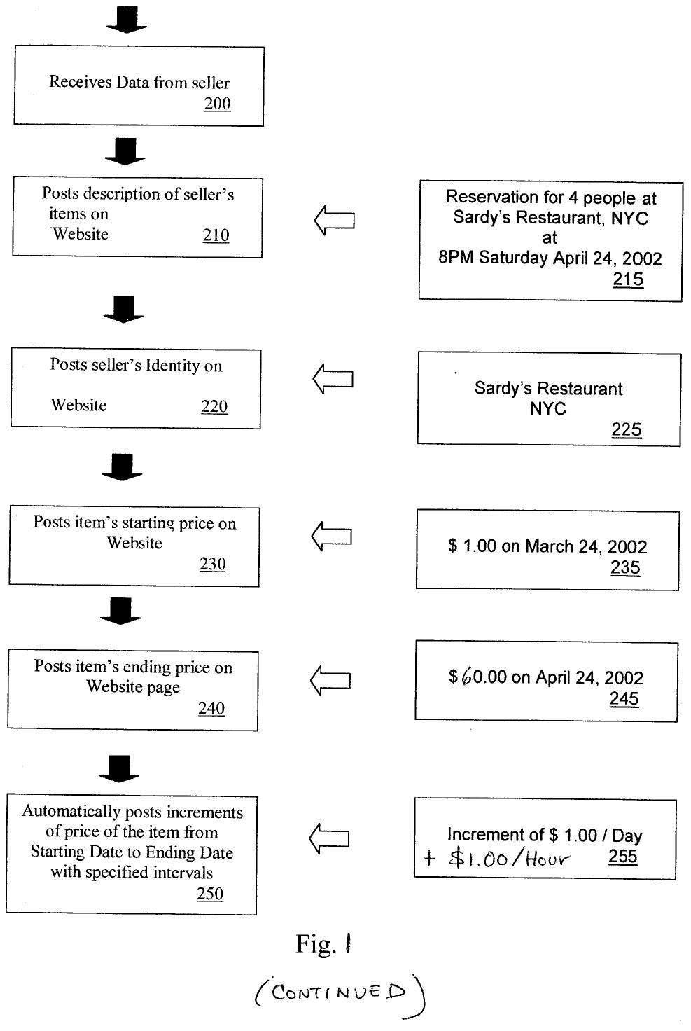

### DESCRIPTION OF THE PREFERRED EMBODIMENT

In the preferred embodiment of the present invention, a method and apparatus is provided whereby sellers of time-critical goods or services may communicate and make available, through a global network, an asking price, which has a predetermined starting price and a predetermined final price, with automatic increasing increments that are made known to buyers who are then able to make a binding offer through the global network at a certain point in time, thereby completing the transaction at the specific price the buyer has contracted and guaranteed to pay with a secure credit card transaction. The credit card will also be billed for any cancellation charges incurred.

In another embodiment of the invention, the automatic increment can be made to be decreasing, so that a larger and larger discount is offered for expiring items that have no takers.

With reference now to the drawings, a new time driven reservation system embodying the principles and concepts of the present invention will be described.

In a preferred embodiment, an Internet server is set up and maintained by a Central Controller. The server runs common Internet Commerce Server application, such as Microsoft's Commerce Server 2002. Sellers who have signed up for the service is given means, such as a password, to access the “backoffice” of the service through the use of a secure connection through the Internet. A Seller, which is typically a restaurateur, a concert promoter, a gift shop, an airline or the like, logs onto the backoffice website of the service set up for sellers through the use of a common Internet browser 110. The Seller then presents his security credentials 115 to the Server application. The Server application verifies this information and the Seller is logged into the backoffice of the service. Once logged on, the seller can manage his account and to list items or services that he wishes to make available through the service. To list an item or service, the seller chooses a Category 120 from a field of pre-determined categories describing the item or service. These might include “Restaurant Reservations,” “Airline Tickets,” “Concert Tickets,” or “Valentine's Day gift,” etc. 125. Once the Category under which the item will be listed is selected, the Seller inputs a brief description of the Item or Service that is being offered 130, 135. A sample description might read “Restaurant Reservation at Sardy's Restaurant, NYC for 4 people, 8 PM, Saturday Apr. 25, 2002” 135. The Seller then determines the Starting Price and the Starting date for the Sale to begin and inputs it to the Server application 140. For example, he chooses a Starting price of $1.00, with a starting date of Mar. 24, 2002 at 00:01 hours 145. The increments for the price, in other words, the increasing premium for making the reservation, is determined next. Here the seller chooses an increment of $1.00/Day and changing to $1.00/Hour on the last day, Apr. 25, 2002 155, and this is input into the server 150. The ending date, as chosen above, ending on 8 PM, Apr. 25, 2002, is inputted into the server program 160. Alternatively, the server program can fill this in from the description entered in step 135. The final ending price, at 8:00 PM on Apr. 24, 2002, is $60.00 (i.e. an increase of $1 per day until 8:00 PM, Apr. 24, 2002, when an increase of $1 per hour until the ending date kicks in) 165. The Commerce Server application receives and verifies the information inputted, and in the preferred embodiment handles all mathematical, time and monetary calculations in order to minimize the chance for errors 200. The information, once verified, is compiled and the server application generates an HTML document for posting on the consumer website 210. The item for sale 210, 215, the seller's identity 220, 225, the starting price 230, 235, and the ending price 240, 245 are linked to an HTML document and posted to the consumer website. At each specified time increment, the Server application automatically updates the value of the premium 250, and the linked value is immediately reflected on the website.

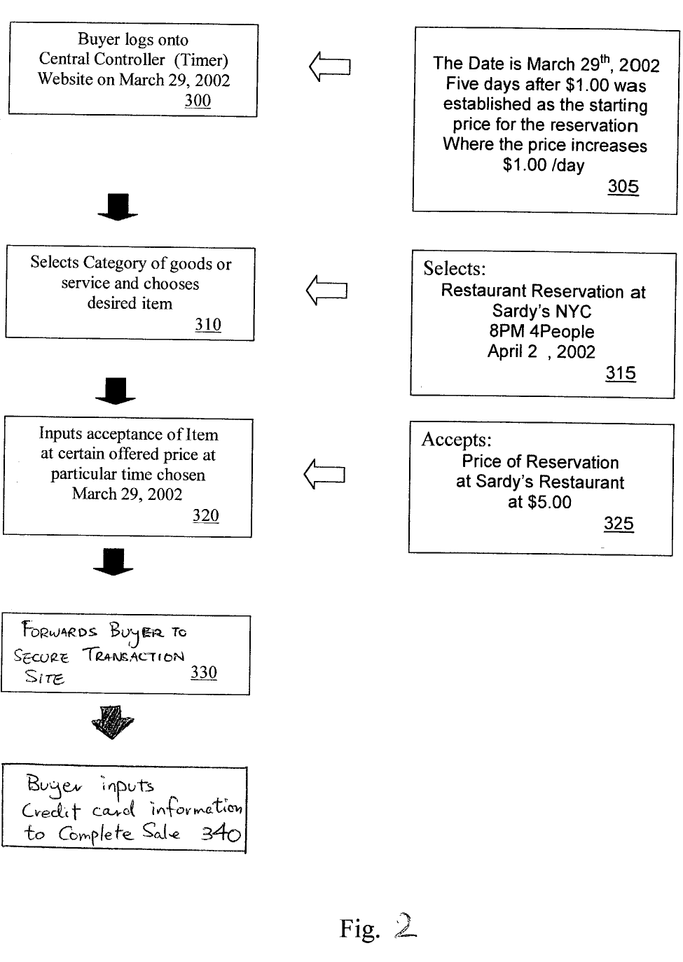

Turning our attention to the actions of a buyer, as depicted in FIG. 2: To initiate a purchase of a reservation, the Buyer logs onto the consumer website of the service 300. In this example, the date is Mar. 29^{th}, 2002, or five days after the sale has begun 305. The Buyer selects the category of goods/services he is interested in, and selects an item 310. In this example, the Buyer chooses the Restaurant Reservation at Sardy's NYC, 8:00 PM on Apr. 25, 2002 315 (as discussed in the Seller's section above). The price increment is $1.00/day, and the reservation now costs $5.00. After reviewing the pricing increments, the Buyer decides to commit to a reservation right now. He accepts the price of the reservation at $5.00 325 and inputs his acceptance of the item 320. The server application then forwards him to a secure transaction site 330, where the service informs him (if it didn't already do so before) of a guarantee that the price offered incrementally is firm at a particular dollar amount once a buyer has inputted the proper credit/debit card information. Finally, the Buyer enters his credit card information to complete the sale 340.

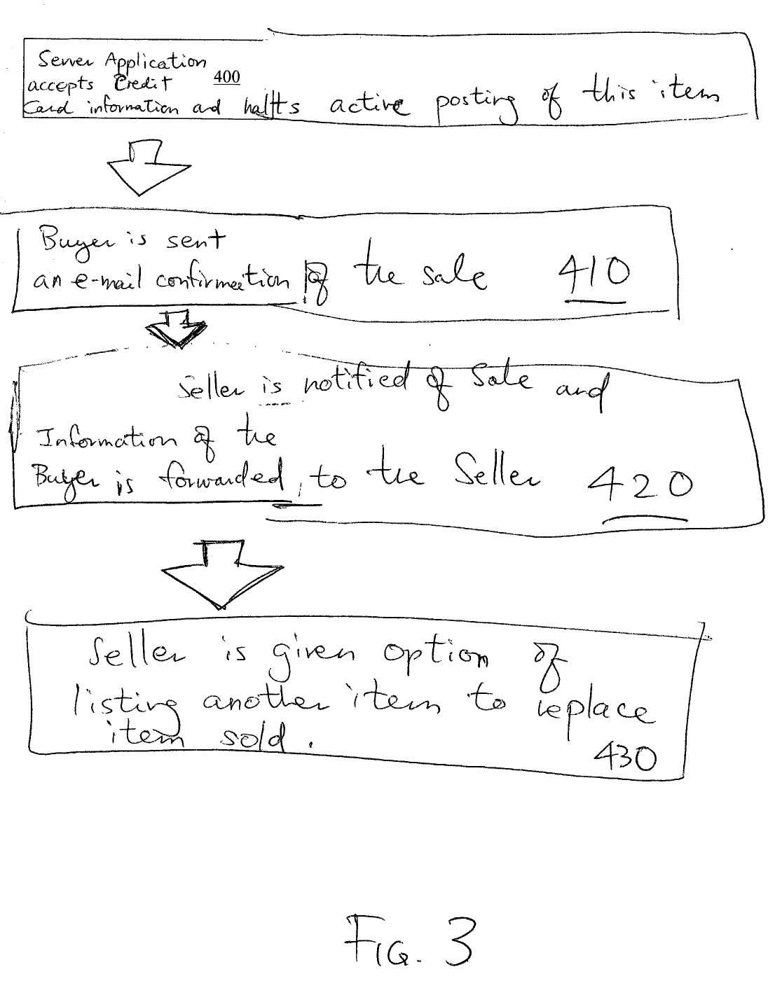

Referring to FIG. 3, immediately after the sale, the server application removes the item from listing on the consumer website 400. The server application sends an automated e-mail confirmation to the Buyer, reminding him of the date and event he purchased. This e-mail can also remind him of any cancellation and/or no-show fees that will be charged to his credit card 410. The Seller is notified of the sale and the name of the buyer is forwarded to the seller 420. Because of the successful sale, the Buyer is given the option of listing another same or similar item 430.

The embodiment described above can also be supplemented by a phone-operated system that can be accessed with a telephone call using automated phone applications known in the art.

The foregoing is considered as illustrative only of the principles of the invention. Further, since numerous modifications and changes will readily occur to those skilled in the art, it is not desired to limit the invention to the exact operation shown and described, and accordingly, all suitable modifications and equivalents may be resorted to, falling within the scope of the invention.

Further, the purpose of the foregoing abstract is to enable the U.S. Patent and Trademark Office and the public generally, and especially the scientists, engineers and practitioners in the art who are not familiar with patent or legal terms or phrascology, to determine quickly from a cursory inspection the nature and essence of the technical disclosure of the application. The abstract is neither intended to define the invention of the application, which is measured by the claims, nor is it intended to be limiting as to the scope of the invention in any way.

I claim:

1. A method for a cryptographically assisted network system capable of communicating and facilitating a time-driven seller asking price, which begins at a predetermined starting price and automatically increases or decreases incrementally to a predetermined final asking price.

2. A method for communication over a network to facilitate a transaction between a seller and at least one buyer, comprising:
inputting into a computer or personal digital device (PDA), by the seller, a specific starting and ending price of a specific item or service that expires on a specific future date,
inputting incremental increases or decreases in the starting price to the final price at a specific date and time,
inputting into a computer the identity of the seller,
inputting into the computer a description of the item or service offered for sale,
inputting into the computer a guarantee that the price offered incrementally is firm at a particular dollar amount once a buyer has inputted the proper credit/debit card information into the payment identifier network.

3. The method of claim 3, in which the step of inputting into a computer an acceptance comprises:
inputting into the computer an acceptance from a buyer at a certain time and price offered at that specific time.

4. The method of claim 3, in which the step in which a buyer accepts a seller's offer at a certain price and time comprises:
a requirement that the buyer must submit proper credit information to secure the purchase before the next pre-determined time increment.

5. The method of claim 3, in which the buyer presents proper credit information and that amount is available comprises:
that the service now automatically reserves the item or service for the buyer and removes it's post on the internet site.

6. The method of claim 4, in which the controller is notified of the amount available from the buyer now transfers the amount of the sale to the seller.
